(19) United States
(12) Patent Application Publication
(10) Pub. No.: US 2024/0165995 A1
(43) Pub. Date: May 23, 2024

(54) Gauge Wheel and Closing Wheel Retainer

(71) Applicant: Jung Enterprise, Inc., Ipswich, SD (US)

(72) Inventor: Allan F. Jung, Ipswich, SD (US)

(21) Appl. No.: 17/992,053

(22) Filed: Nov. 22, 2022

(51) Int. Cl. B60B 35/04; A01B 76/00; B60B 35/02; F16C 17/02; F16C 19/08

(52) U.S. Cl. CPC B60B 35/04; A01B 76/00; B60B 35/025; F16C 17/02; F16C 19/08; F16C 2326/02

(57) ABSTRACT

A wheel retainer that retains a wheel on a wheel mount and prevents the wheel from being fully separated from the wheel mount in the event of a failure of a wheel bearing. In some embodiments, a wheel retainer includes a sleeve, and a retaining member coupled to the sleeve. The retaining member has a retaining diameter sized such that when a wheel bearing fails, a wheel mounted on the wheel bearing is retained at least partially on the sleeve by the retaining member.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### FIELD OF THE DISCLOSURE

The described example embodiments in general relate to a retainer for a wheel, and more specifically, to a retainer for gauge wheels, closing wheels, or other types of wheels typically found on agricultural machinery.

### BACKGROUND

Modern agriculture relies on large-scale machinery for the successful planting, maintenance, and harvesting of crops. One example is a planter that automates the process of planting seeds, such as corn. Planters may be self-propelled or may be drawn behind a tractor. Generally, as the planter moves over a field, the planter operates to simultaneously plant numerous rows of seeds (e.g. 12-48 rows) with uniform spacing between rows, and uniform spacing between seeds, and at suitable depths below the ground surface. In this way, large fields may be efficiently and effectively planted using the planter.

Even with proper maintenance, planters and other useful agricultural machines are subject to significant wear and tear during normal operations, and it is not uncommon for some of the components to wear out. For example, over time and extended use, the bearings of some of the wheels involved in the planting process may become worn out and fail, causing a wheel to simply fall off the planter. Since such failures may not be immediately apparent to an operator, wheels may be lost in the fields, which results in replacement costs and may cause undesirable delays in agricultural operations. Accordingly, although desirable results have been achieved using prior art devices, there is room for improvement.

### SUMMARY

Some of the various embodiments of the present disclosure relate to a wheel retainer that can retain a wheel on a wheel mount and prevent the wheel from being fully separated from the wheel mount in the event of a failure of a wheel bearing. Wheel retainers in accordance with the present disclosure may reduce costs associated with replacement of wheels, and may reduce undesirable delays in machine operation associated with searching for missing wheels, ordering replacement wheels, or other possible delays.

For example, in some embodiments of the present disclosure, a wheel retainer includes a sleeve, and a retaining member coupled to the sleeve. The retaining member has a retaining diameter sized such that when a wheel bearing fails, a wheel mounted on the wheel bearing is retained at least partially on the sleeve by the retaining member.

More specifically in some embodiments, a wheel retainer comprises a sleeve having an internal diameter sized to receive a shaft of a mounting bolt that engages to a wheel mount, the sleeve having an inner end configured to be positioned proximate to a wheel bearing positioned proximate to the wheel mount, and an outer end opposite from the inner end. A retaining member may be coupled to the sleeve proximate to the outer end, the retaining member having a retaining diameter sized such that when the wheel bearing fails, a wheel mounted on the wheel bearing is retained at least partially on the sleeve by the retaining member.

In some embodiments, the retaining member may include an annular retaining member. In further embodiments, the retaining member is coupled to the sleeve by a weldment that peripherally surrounds the outer end of the sleeve, the weldment being configured to engage a head of the mounting bolt when the mounting bolt is inserted through the sleeve into engagement with the wheel mount. In alternate embodiments, the head of the mounting bolt may engage either the outer end of the sleeve, or the retaining member, or both.

In further embodiments, a wheel assembly comprises a wheel bearing configured to be coupled to a wheel mount, a wheel operatively coupled to the wheel bearing, and a wheel retainer positioned proximate to at least one of the wheel or the wheel bearing. The wheel retainer includes a sleeve having an internal diameter sized to receive a shaft of a mounting bolt that engages to the wheel mount, the sleeve having an inner end configured to be positioned proximate to the wheel bearing, and an outer end opposite from the inner end. A retaining member is coupled to the sleeve proximate to the outer end, the retaining member having a retaining diameter sized such that when the wheel bearing fails, the wheel is retained at least partially on the sleeve by the retaining member.

There has thus been outlined, rather broadly, some of the embodiments of the present disclosure in order that the detailed description thereof may be better understood, and in order that the present contribution to the art may be better appreciated. There are additional embodiments that will be described hereinafter and that will form the subject matter of the claims appended hereto. In this respect, before explaining at least one embodiment in detail, it is to be understood that the various embodiments are not limited in its application to the details of construction or to the arrangements of the components set forth in the following description or illustrated in the drawings. Also, it is to be understood that the phraseology and terminology employed herein are for the purpose of the description and should not be regarded as limiting.

To better understand the nature and advantages of the present disclosure, reference should be made to the following description and the accompanying figures. It is to be understood, however, that each of the figures is provided for the purpose of illustration only and is not intended as a definition of the limits of the scope of the present disclosure. Also, as a general rule, and unless it is evidence to the contrary from the description, where elements in different figures use identical reference numbers, the elements are generally either identical or at least similar in function or purpose.

### BRIEF DESCRIPTION OF THE DRAWINGS

FIG. 1 is a side elevational view of an operating environment in which a wheel retainer in accordance with an example embodiment may be implemented.

FIG. 2 is a perspective view of a gauge wheel assembly that includes a wheel retainer in accordance with an example embodiment.

FIG. 3 is an enlarged side view of the gauge wheel assembly of FIG. 2 in accordance with an example embodiment.

FIG. 4 is a side cross-sectional view of a portion of the gauge wheel assembly taken along line A-A of FIG. 2 in accordance with an example embodiment.

FIG. 5 is a perspective view of the wheel retainer of FIG. 2 in accordance with an example embodiment.

FIG. 6 is another perspective view of the wheel retainer of FIG. 2 in accordance with an example embodiment.

FIG. 7 is top elevational view of the wheel retainer of FIG. 2 in accordance with an example embodiment.

FIG. 8 is a perspective view of a closing wheel assembly that includes a wheel retainer in accordance with another example embodiment.

FIG. 9 is an enlarged perspective view of the closing wheel assembly of FIG. 8 in accordance with another example embodiment.

FIG. 10 is an enlarged side view of the closing wheel assembly of FIG. 8 in accordance with another example embodiment.

FIG. 11 is a side cross-sectional view of a portion of the closing wheel assembly taken along line B-B of FIG. 8 in accordance with an example embodiment.

FIG. 12 is top elevational view of a cross-shaped wheel retainer in accordance with another example embodiment.

FIG. 13 is top elevational view of a quadrilateral-shaped wheel retainer in accordance with another example embodiment.

FIG. 14 is top elevational view of a polygonal-shaped wheel retainer in accordance with another example embodiment.

FIG. 15 is a perspective view of a wheel retainer engaged with a mounting bolt and a wheel bearing in accordance with another example embodiment.

FIG. 16 is another perspective view of the wheel retainer of FIG. 15 in accordance with an example embodiment.

FIG. 17 is another side cross-sectional view of a portion of a gauge wheel assembly that includes the wheel retainer of FIG. 15 in accordance with another example embodiment.

FIG. 18 is a perspective view of a wheel retainer in accordance with still another example embodiment.

### DETAILED DESCRIPTION

### A. Overview

Some of the various embodiments of the present disclosure relate to a wheel retainer that can retain a wheel on a wheel mount and prevent the wheel from being fully separated from the wheel mount in the event of a failure of a wheel bearing. For example, in some embodiments, a wheel retainer includes a sleeve, and a retaining member coupled to the sleeve. The retaining member has a retaining diameter sized such that when a wheel bearing fails, a wheel mounted on the wheel bearing is retained at least partially on the sleeve by the retaining member.

The following detailed description of example embodiments refers to the accompanying drawings. The same reference numbers in different drawings may be used to identify the same or similar elements.

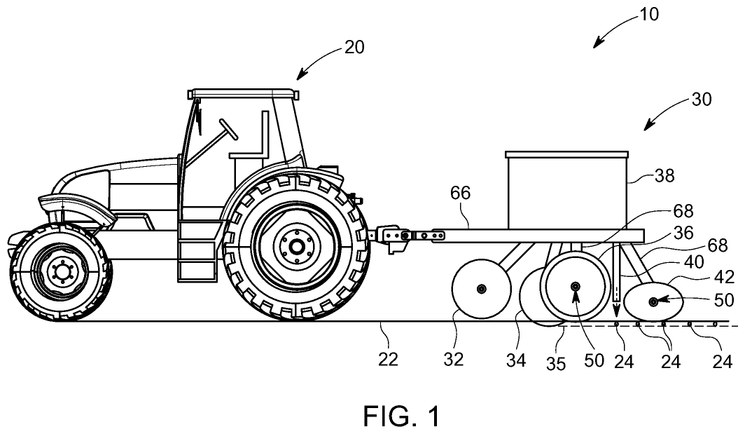

FIG. 1 is a side elevational view of an operating environment 10 in which a wheel retainer 50 in accordance with an example embodiment may be implemented. It will be appreciated that the operating environment 10 shown in FIG. 1 is merely one possible environment in which embodiments of wheel retainers in accordance with the present disclosure may be implemented, and is presented to facilitate an understanding of the exemplary embodiments disclosed herein. Accordingly, the exemplary embodiments of wheel retainers disclosed herein should not be construed as being limited to the particular operating environment 10 shown in FIG. 1.

As shown in FIG. 1, a tractor 20 may pull a planter 30 over a ground surface 22 to plant one or more rows of seeds 24. The planter 30 typically includes a series of components that operate to efficiently plant each row of seeds 24. For example, in the embodiment shown in FIG. 1, the planter 30 includes a cleaner wheel 32 that leads along each row to be planted and has blades that help to cut and remove debris along the row where the seeds 24 will be planted. The planter 30 also includes one or more disc blades 34 that open the ground and create a trench 35 into which the seeds 24 will be deposited. A gauge wheel 36 rolls along the ground surface 22 proximate the newly opened trench 35 and causes seeds 24 from a seed supply 38 (e.g. seed box, hopper, etc.) to be ejected through a seed tube 40 to be deposited into the trench 35 at a desired spacing. In some embodiments, the planter 30 includes a wheel retainer 50 that secures the gauge wheel 36, as described more fully below.

As shown in FIG. 1, the planter 30 further includes closing wheel 42 that is secured by another wheel retainer 50. The closing wheel 42 may be tilted with respect to vertical, and is be configured to push the dirt back into the trench 35, covering the seeds 24. In this way, the planter 30 efficiently and effectively plants each row of seeds 24. By duplicating the above-noted components in a side-by-side orientation, the planter 30 may be configured to plant numerous rows of seeds 24 simultaneously (e.g. 12-48 rows).

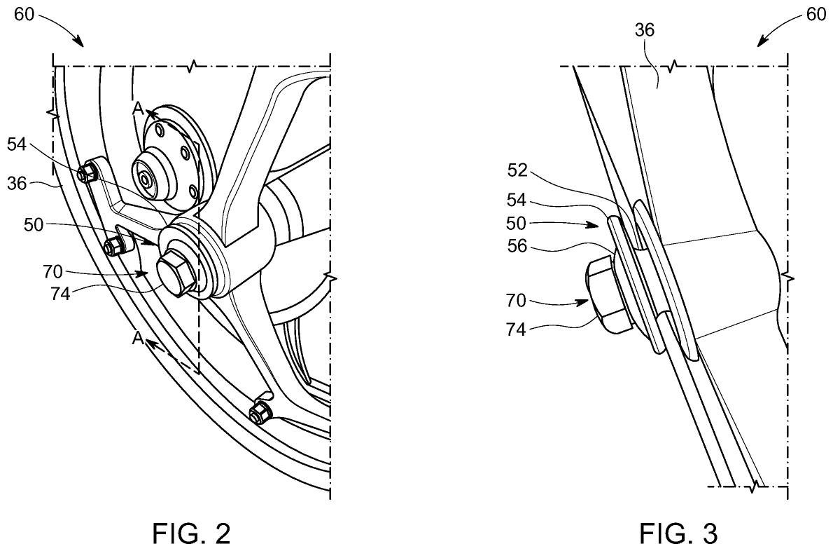

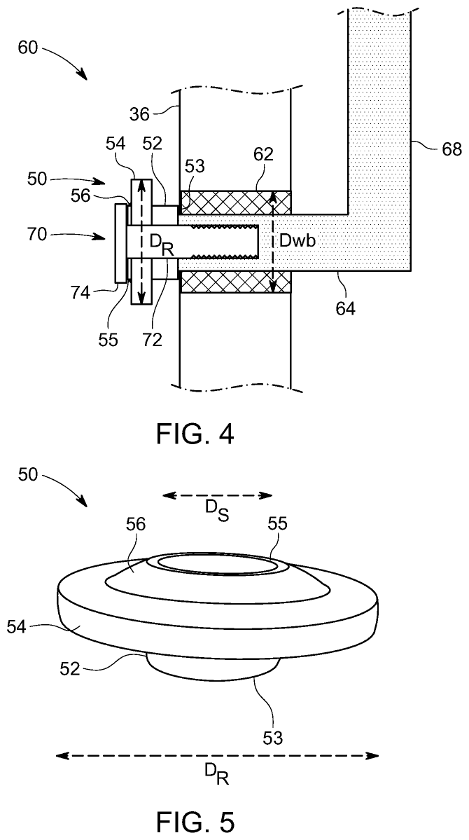

As noted above, the planter 30 advantageously includes the wheel retainers 50 that secure both the gauge wheel 36 and the closing wheel 42. FIG. 2 shows a perspective view of a gauge wheel assembly 60 that includes the wheel retainer 50 in accordance with an example embodiment. Similarly, FIG. 3 is an enlarged side view of the gauge wheel assembly 60, and FIG. 4 is a side cross-sectional view of a portion of the gauge wheel assembly 60 of FIG. 2.

As best shown in FIG. 4, the gauge wheel assembly 60 includes a wheel bearing 62 mounted onto a wheel mount 64, and the gauge wheel 36 is operatively coupled to the wheel bearing 62 which enables the gauge wheel 36 to roll along the ground surface 22. In some embodiments, the wheel mount 64 is coupled to a frame 66 (FIG. 1) of the planter 30 by a strut 68. The wheel retainer 50 is positioned proximate to (or adjacent to) the gauge wheel 36 and the wheel bearing 62, and a mounting bolt 70 passes thru the wheel retainer 50 and threadedly engages into the wheel mount 64, securing the wheel retainer 50 onto the wheel mount 64. More specifically, as shown in FIG. 4, the wheel retainer 50 is positioned laterally outwardly (with respect to the wheel mount 64) from at least one of the gauge wheel 36 or the wheel bearing 62.

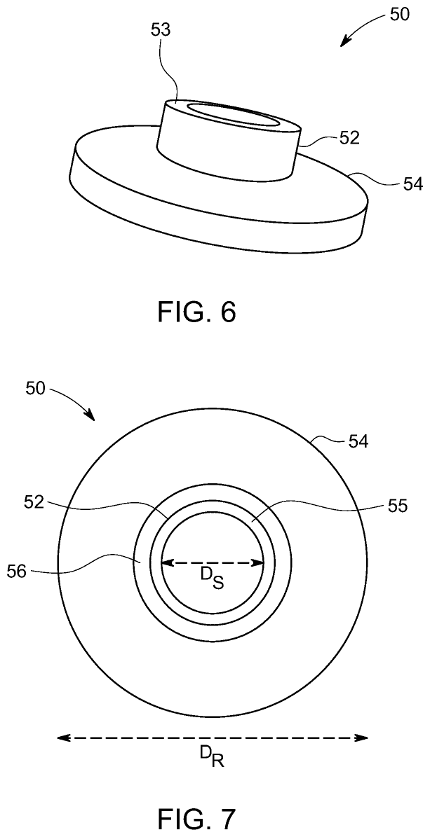

FIGS. 5 and 6 show perspective views of the wheel retainer 50 of FIG. 2 in accordance with an example embodiment. FIG. 7 is a top elevational view of the wheel retainer 50 of FIG. 2. As shown in FIGS. 4-7, in at least some embodiments, the wheel retainer 50 includes a sleeve 52, and a retaining member 54 coupled to the sleeve 52. In some embodiments, the sleeve 52 comprises a cylindrical sleeve 52, and the retaining member 54 comprises an annular retaining member, although in alternate embodiments, members having other suitable shapes may be employed.

As best shown in FIGS. 4 and 7, in some embodiments, the sleeve 52 has an internal sleeve diameter D_{S} sized to receive a shaft 72 of the mounting bolt 70 that secures the wheel retainer 50 to the wheel mount 64. The sleeve 52 has an inner end 53 configured to be positioned proximate to (or engaged against) the wheel bearing 62, and an outer end 55 opposite from the inner end 53. In some embodiments, the retaining member 54 is coupled to the sleeve 52 proximate to the outer end 55, and the retaining member 54 has a retaining diameter D_{R} sized such that when the wheel bearing 62 fails, the gauge wheel 36 mounted on the wheel bearing 62 is retained at least partially on the sleeve 52 by the retaining member 54.

More specifically, in some embodiments, the retaining diameter D_{R} of the retaining member 54 is larger than a bearing diameter D_{wb} of the wheel bearing 62 (see FIG. 4). In some embodiments, the retaining diameter D_{R} of the retaining member 54 is larger than the bearing diameter D_{wb} of the wheel bearing 62 such that when the wheel bearing 62 fails, the gauge wheel 36 mounted on the wheel bearing 62 is retained at least partially on the sleeve 52 by the retaining member 54 and does not become fully separated from the wheel mount 64.

The wheel retainer 50 may be fabricated from a variety of suitable materials. For example, in some embodiments, the wheel retainer 50 may be formed of steel, aluminum, titanium, iron, brass, or any other suitable metals or alloys. Alternately, in some embodiments, the wheel retainer 50 may be formed of relatively high strength polymeric materials, ceramic materials, or synthetic materials (e.g. composite materials, fiber-reinforced resins, etc.), or any other suitable materials.

Furthermore, in some embodiments, the sleeve 52 and the retaining member 54 may be formed separately and then coupled together by a suitable bonding process. For example, in some embodiments, the sleeve 52 and the retaining member 54 may be formed of steel and then welded together. In other embodiments, the sleeve 52 and the retaining member 54 may be integrally formed, such as by machining the wheel retainer 50 from stock, or by casting, molding, three-dimensional (3D) printing, or any other suitable manufacturing processes.

With continued reference to FIGS. 4, 5, and 7, in some embodiments, the retaining member 54 of the wheel retainer 50 is coupled to the sleeve 52 by a weldment 56 that peripherally surrounds the outer end 55 of the cylindrical sleeve 52. In some embodiments, the weldment 56 is configured to engage a head 74 of the mounting bolt 70 when the mounting bolt 70 is inserted through the sleeve 52 into engagement with the wheel mount 64. In some embodiments, the head 74 of the mounting bolt 70 may engage against the outer end 55 of the sleeve 52 when the mounting bolt 70 is inserted through the sleeve 52 into engagement with the wheel mount 64. And in some embodiments, the head 74 of the mounting bolt 70 may engage against both the outer end 55 of the sleeve 52 and the weldment 56 when the mounting bolt 70 is inserted through the sleeve 52 into engagement with the wheel mount 64. In further embodiments, when the weldment 56 is eliminated, the head 74 of the mounting bolt 70 may engage against the outer end 55 of the sleeve 52, the retaining member 54, or both.

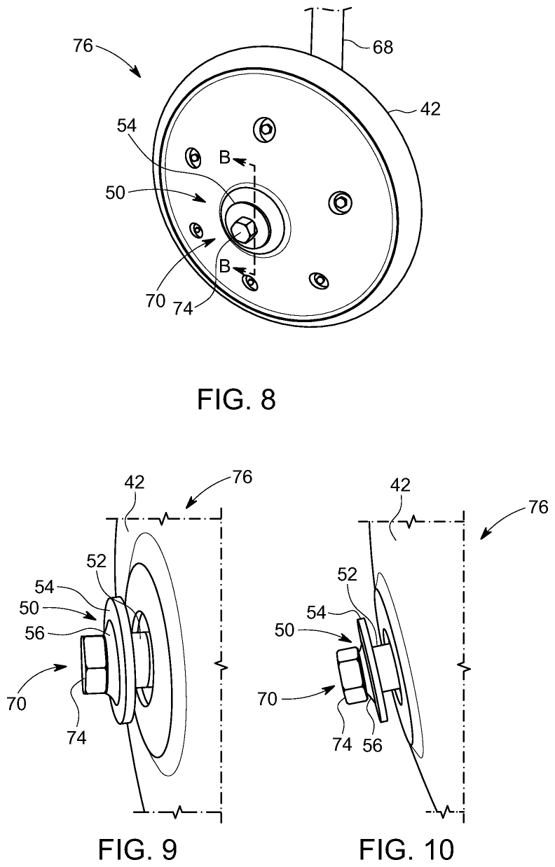

As mentioned above, the planter 30 shown in FIG. 1 also includes another wheel retainer 50 that secures the closing wheel 42. (FIG. 1). FIGS. 8-10 show perspective views of a closing wheel assembly 76 that includes the wheel retainer 50 in accordance with an exemplary embodiment. FIG. 11 shows a side cross-sectional view of a portion of the closing wheel assembly 76 of FIG. 8 in accordance with an example embodiment.

It will be appreciated that the closing wheel assembly 76 (FIGS. 8-11) is similar to the gauge wheel assembly 60 described above and shown in FIGS. 2-4. As best shown in FIG. 11, the closing wheel assembly 76 includes a wheel bearing 62 mounted onto a wheel mount 64, and the closing wheel 42 is operatively coupled to the wheel bearing 62. In some embodiments, the wheel mount 64 is tilted (or non-horizontal) so that as the closing wheel 42 engages the ground surface 22, it is configured to push the dirt back into the trench 35, covering the seeds 24 (see FIG. 1). More specifically, the wheel mount 64 is tilted so that the closing wheel 42 engages the ground surface 22 in a non-vertical orientation. The wheel mount 64 of the closing wheel assembly 76 may be coupled to the frame 66 (FIG. 1) of the planter 30 by a strut 68.

As further shown in FIG. 11, the wheel retainer 50 is positioned proximate to (or adjacent to) the closing wheel 42 and the wheel bearing 62, and a mounting bolt 70 passes thru the wheel retainer 50 and threadedly engages into the wheel mount 64, securing the closing wheel 42 onto the wheel mount 64. More specifically, in at least some embodiments, the wheel retainer 50 is positioned laterally outwardly (with respect to the wheel mount 64) from at least one of the closing wheel 36 or the wheel bearing 62.

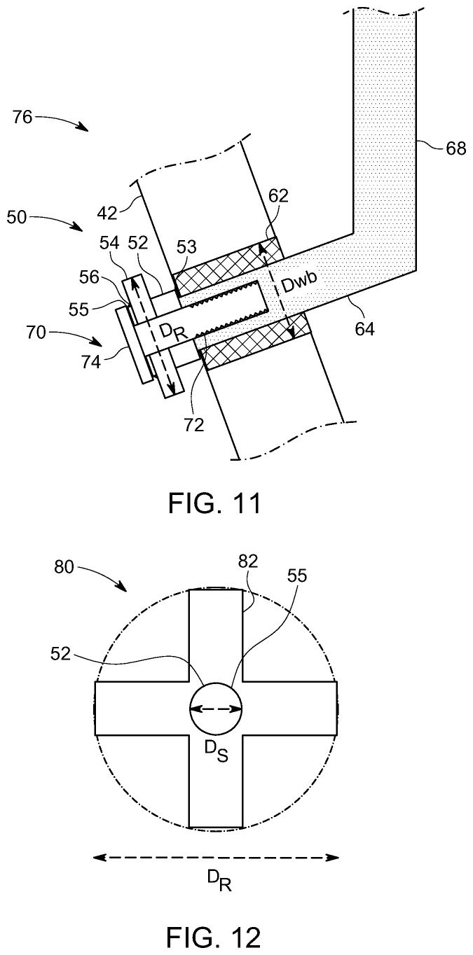

As noted above, in some embodiments, the retaining member 54 may be an annular retaining member. In other exemplary embodiments, however, retaining members of wheel retainers in accordance with the present disclosure may have other suitable shapes, including cross shapes, quadrilateral shapes, polygonal shapes, or any other suitable shapes (or combinations of shapes). For example, FIG. 12 is top elevational view of a wheel retainer 80 having a cross-shaped retaining member 82 coupled to a sleeve 52 in accordance with an example embodiment. As described above, the internal sleeve diameter D_{S} of the sleeve 52 is sized to receive the shaft 72 of the mounting bolt 70 that secures the wheel retainer 80 to the wheel mount 64. In this embodiment, as shown in FIG. 12, the retaining diameter D_{R} refers to a diameter of a circle encompassing the dimensions of the cross-shaped retaining member 82. In some embodiments, the retaining member 82 is coupled to the sleeve 52 proximate to the outer end 55 of the sleeve 52, and the retaining member 82 has a retaining diameter D_{R} sized such that when the wheel bearing 62 fails, the gauge wheel 36 (or closing wheel 42, or any other wheel) mounted on the wheel bearing 62 is retained at least partially on the sleeve 52 by the retaining member 82.

More specifically, in some embodiments, the retaining diameter D_{R} of the retaining member 82 is larger than a bearing diameter D_{wb} of the wheel bearing 62 (e.g. see FIG. 4). In some embodiments, the retaining diameter D_{R} of the retaining member 82 is larger than the bearing diameter D_{wb} of the wheel bearing 62 such that when the wheel bearing 62 fails, the gauge wheel 36 (or any other wheel) mounted on the wheel bearing 62 is retained at least partially on the sleeve 52 by the retaining member 82 and does not become fully separated from the wheel mount 64.

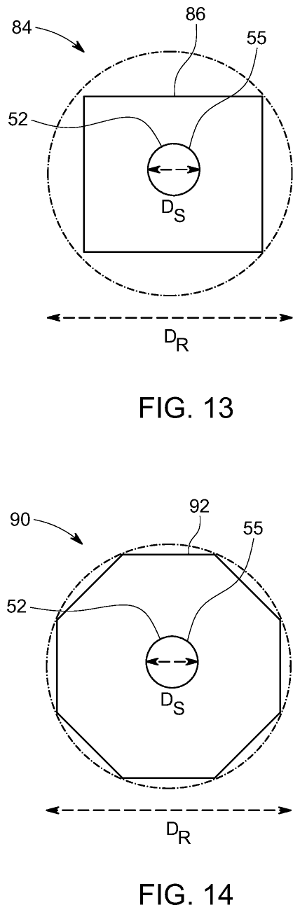

Similarly, FIG. 13 is top elevational view of a wheel retainer 84 having a quadrilateral-shaped retaining member 86 coupled to a sleeve 52 in accordance with an example embodiment. The quadrilateral-shaped retaining member 86 may be square, rectangular, or any other suitable quadrilateral shape. As described above, the internal sleeve diameter D_{S} of the sleeve 52 is sized to receive the shaft 72 of the mounting bolt 70 that secures the wheel retainer 84 to the wheel mount 64. In this embodiment, as shown in FIG. 13, the retaining diameter D_{R} refers to a diameter of a circle encompassing the dimensions of the quadrilateral-shaped retaining member 86. In some embodiments, the retaining member 86 is coupled to the sleeve 52 proximate to the outer end 55 of the sleeve 52, and the retaining member 86 has a retaining diameter D_{R} sized such that when the wheel bearing 62 fails, the gauge wheel 36 (or closing wheel 42, or any other wheel) mounted on the wheel bearing 62 is retained at least partially on the sleeve 52 by the retaining member 86.

More specifically, in some embodiments, the retaining diameter D_{R} of the retaining member 86 is larger than a bearing diameter D_{wb} of the wheel bearing 62 (e.g. see FIG. 4). In some embodiments, the retaining diameter D_{R} of the retaining member 86 is larger than the bearing diameter D_{wb} of the wheel bearing 62 such that when the wheel bearing 62 fails, the gauge wheel 36 (or any other wheel) mounted on the wheel bearing 62 is retained at least partially on the sleeve 52 by the retaining member 86 and does not become fully separated from the wheel mount 64.

In addition, FIG. 14 is top elevational view of a wheel retainer 90 having a quadrilateral-shaped retaining member 92 coupled to a sleeve 52 in accordance with an example embodiment. The quadrilateral-shaped retaining member 92 may be an octogon, triangle, pentagon, hexagon, star-shape, regular or irregular polygon, or any other suitable polygon shape. As described above, the internal sleeve diameter D_{S} of the sleeve 52 is sized to receive the shaft 72 of the mounting bolt 70 that secures the wheel retainer 90 to the wheel mount 64. In this embodiment, as shown in FIG. 14, the retaining diameter D_{R} refers to a diameter of a circle encompassing the dimensions of the polygonal-shaped retaining member 92. In some embodiments, the retaining member 92 is coupled to the sleeve 52 proximate to the outer end 55 of the sleeve 52, and the retaining member 92 has a retaining diameter D_{R} sized such that when the wheel bearing 62 fails, the gauge wheel 36 (or closing wheel 42, or any other wheel) mounted on the wheel bearing 62 is retained at least partially on the sleeve 52 by the retaining member 92.

More specifically, in some embodiments, the retaining diameter D_{R} of the retaining member 92 is larger than a bearing diameter D_{wb} of the wheel bearing 62 (e.g. see FIG. 4). In some embodiments, the retaining diameter D_{R} of the retaining member 92 is larger than the bearing diameter D_{wb} of the wheel bearing 62 such that when the wheel bearing 62 fails, the gauge wheel 36 (or any other wheel) mounted on the wheel bearing 62 is retained at least partially on the sleeve 52 by the retaining member 92 and does not become fully separated from the wheel mount 64.

Although several exemplary embodiments of wheel retainers have been described above and shown in the accompanying figures for a few suitable shapes of retaining members, it will be appreciated that virtually any number of suitable shapes (or combinations of shapes) of the retaining members for wheel retainers may be conceived. Similarly, it will be appreciated that virtually any number of sleeves for wheel retainers may be conceived having different dimensions, different cross-sectional shapes, or other differing characteristics from the particular embodiments shown and described above. Accordingly, wheel retainers in accordance with the present disclosure should not be construed as being limited to the particular exemplary embodiments described above and shown in the accompanying figures.

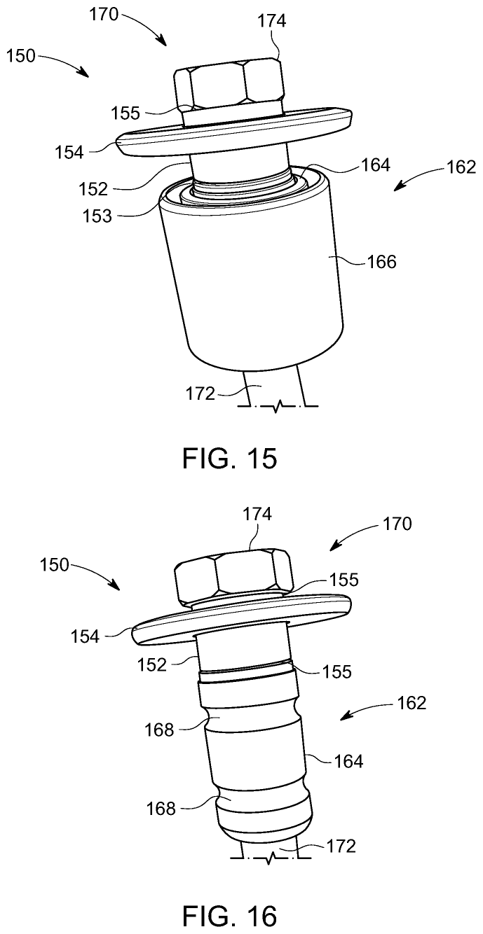

It will be appreciated that further exemplary embodiments in accordance with the present disclosure may be readily conceived. For example, FIG. 15 is a perspective view of a wheel retainer 150 in accordance with another example embodiment. The wheel retainer 150 includes a sleeve 152 that slidably receives a shaft 172 of a mounting bolt 170, and a retaining member 154 extending outwardly from an outer surface of the sleeve 152. In some embodiments, the sleeve 152 has an internal sleeve diameter D_{S} sized to receive the shaft 172 of the mounting bolt 170 that secures the wheel retainer 150 and the wheel bearing 162 to the wheel mount 64. In some embodiments, the retaining member 154 and the sleeve 152 may be integrally formed, that is, formed of a single piece, unitary construction of the type that may be produced by machining or other fabrication processes, thereby eliminating the weldment 56 described above.

As further shown in FIG. 15, the wheel retainer 150 is mounted onto the mounting bolt 170 with a head 174 of the mounting bolt 170 engaging an outer end 155 of the sleeve 152. A wheel bearing 162 is also engaged onto the shaft 172 of the mounting bolt 170. In some embodiments, the wheel bearing 162 includes an inner race 164 that engages the shaft 172 of the mounting bolt 170, and an outer race 166. FIG. 16 is another perspective view of the wheel retainer 150 of FIG. 15. In this view, the wheel bearing 162 is partially disassembled such that only the inner race 164 is visible.

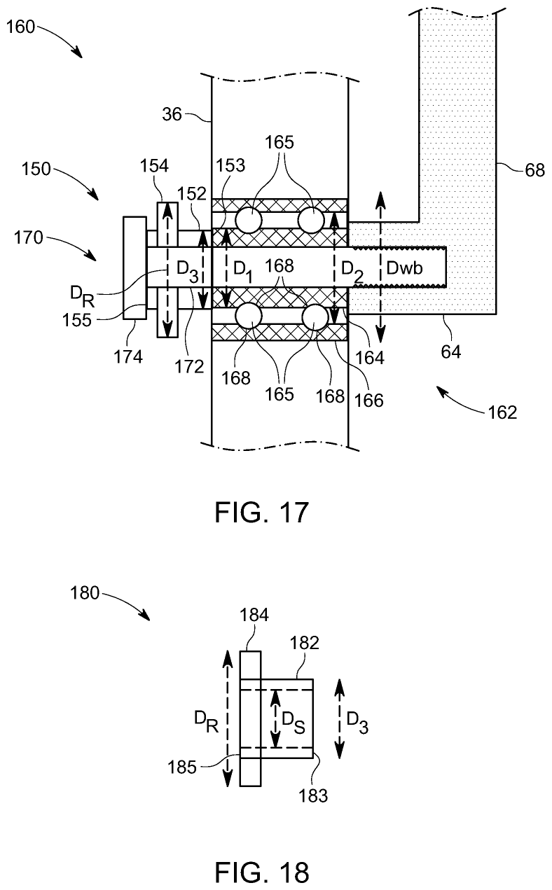

FIG. 17 is another side cross-sectional view of a portion of a gauge wheel assembly 160 that includes the wheel retainer 150 and wheel bearing 162 of FIG. 15 in accordance with another example embodiment. As shown in FIG. 17, in some embodiments, the wheel bearing 162 is mounted on the shaft 172 of the mounting bolt 170 and is positioned between the wheel retainer 150 and the wheel mount 64. The gauge wheel 36 is mounted onto the outer race 168 of the wheel bearing 162. In some embodiments, the wheel bearing 162 includes a plurality of ball bearings 165 (e.g. four are shown in FIG. 17) that roll within grooves 168 disposed within opposing surfaces of the inner and outer races 164, 166 in a generally known configuration.

As further shown in FIG. 17, the wheel bearing 162 has an outer bearing diameter D_{wb}. Also, the inner race 164 of wheel bearing 164 has an outer diameter D₁, while the outer race 166 of the wheel bearing 164 has an inner diameter D₂. As with the previously-described embodiments, the retaining member 154 of the wheel retainer 150 has a retaining diameter D_{R}.

As described above, in some embodiments, the retaining diameter D_{R} of the retaining member 174 is larger than the bearing diameter D_{wb} of the wheel bearing 162 (e.g. see FIG. 17). In some embodiments, however, the retaining diameter D_{R} of the retaining member 174 may be smaller than the bearing diameter D_{wb} of the wheel bearing 162, but larger than the inner diameter D 2 of the outer race 166 of the wheel bearing 162. The retaining member 154 is configured with a sufficient retaining diameter D_{R} such that when the wheel bearing 162 fails, such as may occur when the outer race 166 becomes separated from the inner race 164, the gauge wheel 36 (or any other wheel) mounted on the outer race 166 of the wheel bearing 162 is retained at least partially on the sleeve 152 by the retaining member 154 and does not become fully separated from the wheel mount 64.

As further shown in FIG. 17, the sleeve 152 of the wheel retainer 150 has an outer sleeve diameter D₃. In some embodiments, the outer sleeve diameter D₃ of the sleeve 152 may be approximately equal to the outer diameter D₁ of the inner race 164 of the wheel bearing 162 (e.g. FIG. 16). In further embodiments, however, the outer sleeve diameter D₃ of the sleeve 152 may be less than or greater than the outer diameter D₁ of the inner race 164 of the wheel bearing 162.

FIG. 18 is a perspective view of a wheel retainer 180 in accordance with still another example embodiment. In some embodiments, the wheel retainer 180 includes a sleeve 182 that slidably receives a shaft 172 of a mounting bolt 170, and a retaining member 184 extending outwardly from an outer surface of the sleeve 182. The sleeve 182 has an inner end 183 that engages against a wheel bearing 162, and an outer end 185 that engages against a head 174 of the mounting bolt 170.

As shown in FIG. 18, in some embodiments, the retaining member 184 is positioned approximately flush with the outer end 185 of the sleeve 182. In some embodiments, the head 174 of the mounting bolt 170 engages against either the outer end 185, the retaining member 184, or both the outer end 185 and the retaining member 184, when the mounting bolt 170 is engaged through the wheel retainer 180 to secure the wheel retainer 180 and the wheel bearing 162 (and the gauge wheel 36 mounted on the wheel bearing 162) to the wheel mount 64. The retaining member 184 is configured with a sufficient retaining diameter D_{R} such that when the wheel bearing 162 fails, the gauge wheel 36 (or any other wheel) mounted on the wheel bearing 162 is retained at least partially on the sleeve 182 by the retaining member 184 and does not become fully separated from the wheel mount 64.

Wheel retainers in accordance with the present disclosure may provide substantial advantages over the prior art. For example, because some wheels operating in relatively harsh environments (e.g. agricultural machines) are subject to significant wear and tear during normal operations, it is not uncommon wheel bearing or other components to wear out. In such environments, when a failure of a wheel bearing occurs, wheels (e.g. gauge wheel 36, closing wheel 42, etc.) may become lost. When wheel retainers in accordance with the present disclosure are employed in such operating environments, however, when the wheel bearing fails, the wheel may nevertheless remain secured to the wheel mount by the retaining member of the wheel retainer, preventing loss of the wheel. Wheel retainers in accordance with the present disclosure may reduce costs associated with replacement of wheels, and may reduce undesirable delays in machine operation associated with searching for missing wheels, ordering replacement wheels, or other possible delays. Accordingly, time and expense associated with wheel bearing failures may be mitigated.

Unless otherwise defined, all technical and scientific terms used herein have the same meaning as commonly understood by one of ordinary skill in the art to which this invention belongs. Although methods and materials similar to or equivalent to those described herein can be used in the practice or testing of the various embodiments of the present disclosure, suitable methods and materials are described above. All patent applications, patents, and printed publications cited herein are incorporated herein by reference in their entireties, except for any definitions, subject matter disclaimers or disavowals, and except to the extent that the incorporated material is inconsistent with the express disclosure herein, in which case the language in this disclosure controls. The various embodiments of the present disclosure may be embodied in other specific forms without departing from the spirit or essential attributes thereof, and it is therefore desired that the various embodiments in the present disclosure be considered in all respects as illustrative and not restrictive. Any headings utilized within the description are for convenience only and have no legal or limiting effect.

What is claimed is:

1. A wheel retainer, comprising:
a sleeve having an internal diameter sized to receive a shaft of a mounting bolt that engages to a wheel mount, the sleeve having an inner end configured to be positioned proximate to a wheel bearing positioned proximate to the wheel mount, and an outer end opposite from the inner end; and
a retaining member coupled to the sleeve proximate to the outer end, the retaining member having a retaining diameter sized such that when the wheel bearing fails, a wheel mounted on the wheel bearing is retained at least partially on the sleeve by the retaining member.

2. The wheel retainer of claim 1, wherein the retaining diameter of the retaining member is greater than a bearing diameter of the wheel bearing.

3. The wheel retainer of claim 1, wherein the retaining diameter of the retaining member is larger than an inner diameter of an outer race of the wheel bearing.

4. The wheel retainer of claim 1, wherein the retaining diameter of the retaining member is larger than an inner diameter of an outer race of the wheel bearing such that when the wheel bearing fails, the wheel mounted on the wheel bearing is retained at least partially on the sleeve by the retaining member and does not become fully separated from the wheel mount.

5. The wheel retainer of claim 1, wherein the retaining member is coupled to the sleeve by a weldment that peripherally surrounds the outer end of the sleeve.

6. The wheel retainer of claim 1, wherein the sleeve comprises a cylindrical sleeve, and wherein the retaining member is coupled to the cylindrical sleeve by a weldment that peripherally surrounds the outer end of the cylindrical sleeve, the weldment being configured to engage a head of the mounting bolt when the mounting bolt is inserted through the cylindrical sleeve into engagement with the wheel mount.

7. The wheel retainer of claim 1, wherein the sleeve comprises a steel cylindrical sleeve and the retaining member comprises a steel annular member.

8. The wheel retainer of claim 1, wherein the sleeve and the retaining member are integrally formed.

9. A wheel assembly, comprising:
a wheel bearing configured to be coupled to a wheel mount;
a wheel operatively coupled to the wheel bearing; and
a wheel retainer positioned proximate to at least one of the wheel or the wheel bearing, the wheel retainer including:
a sleeve having an internal diameter sized to receive a shaft of a mounting bolt that engages to the wheel mount, the sleeve having an inner end configured to be positioned proximate to the wheel bearing, and an outer end opposite from the inner end; and
a retaining member coupled to the sleeve proximate to the outer end, the retaining member having a retaining diameter sized such that when the wheel bearing fails, the wheel is retained at least partially on the sleeve by the retaining member.

10. The wheel assembly of claim 9, wherein the retaining diameter of the retaining member is larger than a bearing diameter of the wheel bearing.

11. The wheel assembly of claim 9, wherein the retaining diameter of the retaining member is larger than an inner diameter of an outer race of the wheel bearing.

12. The wheel assembly of claim 9, wherein the retaining diameter of the retaining member is larger than an inner diameter of an outer race of the wheel bearing such that when the wheel bearing fails, the wheel is retained at least partially on the sleeve by the retaining member and does not become fully separated from the wheel mount.

13. The wheel assembly of claim 9, wherein the retaining member is coupled to the sleeve by a weldment that peripherally surrounds the outer end of the sleeve, the weldment being configured to engage a head of the mounting bolt when the mounting bolt is inserted through the sleeve into engagement with the wheel mount.

14. The wheel assembly of claim 9, wherein the retaining member comprises at least one of an annular member, a cross-shaped member, a quadrilateral-shaped member, or a polygonal-shaped member.

15. A machine, comprising:
a frame; and
a wheel assembly operatively coupled to the frame, the wheel assembly including:
a wheel mount coupled to the frame;
a wheel bearing configured to be coupled to the wheel mount;
a wheel operatively coupled to the wheel bearing; and
a wheel retainer positioned proximate to at least one of the wheel or the wheel bearing, the wheel retainer including:
a sleeve having an internal diameter sized to receive a shaft of a mounting bolt that engages to the wheel mount, the sleeve having an inner end configured to be positioned proximate to at least one of the wheel or the wheel bearing, and an outer end opposite from the inner end; and
a retaining member coupled to the sleeve proximate to the outer end, the retaining member having a retaining diameter sized such that when the wheel bearing fails, the wheel is retained at least partially on the sleeve by the retaining member.

16. The machine of claim 15, wherein the sleeve comprises a cylindrical sleeve and wherein the retaining diameter of the retaining member is larger than an inner diameter of an outer race of the wheel bearing such that when the wheel bearing fails, the wheel is retained at least partially on the cylindrical sleeve by the retaining member and does not become fully separated from the wheel mount.

17. The machine of claim 15, wherein the retaining member is coupled to the sleeve such that the retaining member is flush with the outer end of the sleeve such that a head of the mounting bolt engages at least one of the outer end or the retaining member when the mounting bolt is inserted through the cylindrical sleeve into engagement with the wheel mount.

18. The machine of claim 15, wherein the retaining member comprises at least one of an annular member, a cross-shaped member, a quadrilateral-shaped member, or a polygonal-shaped member.

19. The machine of claim 15, wherein the wheel retainer is positioned laterally outwardly from the wheel bearing.

20. The machine of claim 15, wherein the wheel comprises a wheel configured to engage a ground surface in at least one of a vertical orientation or a non-vertical orientation.
